(19) United States
(12) Patent Application Publication
(10) Pub. No.: US 2024/0026168 A1
(43) Pub. Date: Jan. 25, 2024

(54) THERMALLY DEBONDABLE COATING COMPOSITIONS AND STRUCTURES MADE THEREFROM

(71) Applicant: Henkel AG & Co. KGaA, Duesseldorf (DE)

(72) Inventors: Wenhua Zhang, Farmington, CT (US); Richard Corrao, Manchester, CT (US); Ling Li, Glastonbury, CT (US)

(21) Appl. No.: 18/372,238

(22) Filed: Sep. 25, 2023

Related U.S. Application Data
(63) Continuation of application No. PCT/US2022/023789, filed on Apr. 7, 2022.
(60) Provisional application No. 63/172,812, filed on Apr. 9, 2021.

(51) Int. Cl. C09D 5/16; C09D 5/26; C09D 7/40; C09D 7/65; C09D 163/00; C09J 5/00

(52) U.S. Cl. CPC C09D 5/1662; C09D 5/26; C09D 7/70; C09D 7/65; C09D 7/69; C09D 163/00; C09J 5/00; C09J 2483/00

(57) ABSTRACT

Curable heat-expanding debondable coating compositions for use as a pre-coating or surface preparation in conjunction with adhesive composition. The debondable coating compositions include heat-expandable microspheres which are designed to expand in a specified temperature range, thereby debonding the coating compositions from a substrate. Adhesive compositions are overlaid on the debonding coating and are subsequently debonded from the substrate along with the debondable coating composition.

### BACKGROUND

### Field

The present disclosure relates to debonding coating compositions are used as a surface treatment on substrates prior to application of a bonding adhesive, potting adhesive or coating adhesive. The debonding coating provides a debondable surface on which the bonding adhesive can bond and maintain the bonding adhesive's strength and properties. The debonding coating, when exposed to heat, debonds (separates or is easily removed) from the substrate, thus allowing the bonding adhesive overlaid thereon to also separate from the substrate.

### BRIEF DESCRIPTION OF RELATED TECHNOLOGY

Thermally expandable particles (TEPs) have been used to make adhesives debondable. This effort often requires significant effort in reformulating and using only chemistries which are compatible with the TEPs. For example, EP 1141104 B1 discloses the use of heat expandable inorganic particles such as graphite, vermiculite, pearlite, mica, wermlandite, thanmasite and hydrotalcite, which are added to an epoxy resin. When heated the particles expand, allowing the adhesive to debond from a substrate. U.S. Pat. No. 10,800,956 B2 to Henkel AG, discloses a debondable reactive hot melt which contain organic or inorganic salts, which when heated cause the hot melt to melt, allowing debonding from the substrate.

Currently, there is a need for a universal debonding coating which can be used with a variety of different adhesives in a variety of different applications, such as bonding, potting and coating applications and which does not require reformulation due to incompatibility concerns.

### SUMMARY

In one aspect of the invention, there is provided an adhesive debonding coating composition for thermally debonding a cured adhesive bond-line from a substrate, said debonding coating including:
a curable adhesive matrix capable of withstanding temperatures greater than about 250° C. when cured, said matrix including about 1% to about 60% by weight of heat expandable polymeric microparticles which expand when subjected to temperatures of about 70° C. to about 250° C.

In another aspect of the invention, there is provided a method of forming debondable adhesion to a substrate which includes:

applying to a surface of said substrate a composition which includes:
a. a first debonding layer including an adhesive matrix and heat expandable microparticles, said microparticles capable of expanding at temperatures of about to about 250° C., and said adhesive matrix capable of withstanding temperatures greater than said expansion temperatures;
b. a second layer including a curable bonding adhesive which is capable of withstanding temperatures greater than the expansion temperatures; and curing said composition on said substrate,
wherein subsequent to said curing, the substrate can be separated from the adhesive layers by heating to said expansion temperature.

In another aspect of the invention there is provided a structure which includes at least one surface, said at least one surface including a cured debonding coating layer in direct contact with said surface and an additional adhesive bonding layer over said debonding coating, wherein said debonding layer includes an adhesive matrix capable of withstanding temperatures greater than about 250° C. and heat expandable microparticles, wherein upon heating the microparticles to a temperature of about 70° to about 250° C., the microparticles expand to cause debonding of the coating and bonding layers from the surface.

In yet another aspect of the invention there is provided a method of forming a debondable adhesion to a substrate which includes:
applying to a surface of said substrate a composition which includes:
a) a first debonding layer in direct contact with said surface, said debonding layer including an adhesive matrix selected from the group consisting of epoxies, silicones, polyurethanes, silicone-modified-polymers and copolymers and combinations thereof, and heat expandable microparticles capable of expanding at temperatures of about to about 250° C.;
b) a second layer overlaying said debonding layer, said second layer including a curable bonding adhesive which has lower adhesive strength, as measured by lapshear tests, than the first debonding layer; and
allowing said composition to cure on said substrate, wherein subsequent to said curing,
the substrate can be separated from the adhesive layers by heating to said expansion temperatures.

In yet another aspect of the invention there is provided a heat-debondable adhesive joint which includes:
a first substrate surface and a second substrate surface, said first and second surfaces in mating arrangement to define a heat debondable adhesive bond-line therebetween;
a debonding coating composition on at least one of said mating surfaces, said coating composition including an epoxy adhesive matrix which includes from about 1% to about 60% by weight of heat expandable microspheres, said microspheres comprising an acrylonitrile shell and a hydrocarbon core; and
an adhesive bonding composition overlaying said debonding coating composition, said bonding composition comprising an adhesive which is compatible with said debonding composition and having a lower adhesive lap shear strength than said debonding composition,
wherein upon activation of a temperature from about 70° C. to about 250° C., the heat expandable microspheres cause debonding of said substrates from each other.

### BRIEF DESCRIPTION OF THE FIGURES

FIG. 1 shows a debonding coating made from commercially available adhesive Loctite E-120HP incorporating about 20% (by weight of the total debonding coating) Expancel® microspheres used as a pre-coating (on aluminum lapshears) for a silicone adhesive (Loctite® SI 6900) joint. The debonding coating did not interfere with the normal bond strength of the silicone adhesive at RT, but allowed for debonding of the lapshears under relatively mild heat conditions.

FIG. 2 shows a debonding coating made from commercially available adhesive Loctite E-90F incorporating about 20% Expancel® microspheres (by weight of the total debonding coating) used as a pre-coating on Aluminum surface, for a silicone adhesive (Loctite® SI 5600) joint. The debonding coating did not interfere with the normal bond strength of the silicone adhesive at RT, but allowed for debonding of the lapshears under relatively mild heat conditions

FIG. 3 is a side view of a debondable structure showing the debonding coating and the adhesive bonding layers respectively.

FIG. 4 is a side view of a debondable structure showing the debonding coating and potting adhesive layers respectively.

FIG. 5 is a side view of a debondable structure showing the debonding coating essentially encapsulating the substrate and adhesive bonding layers respectively

### DETAILED DESCRIPTION

The present disclosure uses a curable adhesive matrix to form a debondable coating which can be used universally as a pre-coating to render a variety of different adhesive compositions debondable. The debonding coating is be applied to the substrate first to form a debondable interface, followed by application of the bonding adhesive compositions. The debonding coating is cured on the substrate prior to application of the bonding adhesive and does not affect the adhesive properties of the bonding adhesive.

Among the advantages of the present disclosure are: a single coating can be used for a wide variety of adhesive formulations, thereby eliminating the compatibility issues common in the prior art; bonded, potted and coated parts can now easily be maintained and serviced, for example replaced or upgraded by debonding; reclamation of parts is greatly facilitated due to debonding and removal of the recoating and adhesive layers; temporary fixtures can be formed and easily separated; and end of part life can be easily handled by replacement. Additionally, the debonding coatings allow for control of debonding through temperature control.

The debonding coating includes a curable matrix which may be selected from epoxies, silicones, polyurethanes and silicone modified polymers, as well as copolymers and combinations of these polymers. Desirably, the curable matrix is capable of withstanding temperatures greater than the bonding adhesive, for example capable of withstanding temperatures of at least about 250° C.

Non-limiting examples of useful epoxy compositions for use as the debonding coating matrix include two part adhesive compositions having an epoxy resin and a curing (hardening) agent such as a polyamide, which when nixed together cause the epoxy to cure. Examples of useful commercially available epoxy compositions are those sold by the Henkel Corporation, such as Loctite Hysol E-90FL, Loctite Hysol E-120HP, Loctite E-30CL, Loctite E-00CL.

Non-limiting examples of useful silicone compositions for use as the debonding coating matrix include moisture curing, uv curing, uv/moisture curing, heat curing and moisture/heat curing compositions. Combinations of silicone compositions (mixtures and copolymers) may also be employed. Examples of useful commercially available silicone compositions are those sold by the Henkel Corporation, such as Loctite SI 5600, Loctite SI 5607, Loctite 5900 et al.

Non-limiting examples of useful polyurethane compositions for use as the debonding coating matrix include polyurethane compositions, such as 1 part moisture cured polyurethane, 2 part polyurethane, polyurea, and combinations thereof. Examples of useful commercially available polyurethane compositions are those sold by the Henkel Corporation, such as Loctite UK 1351, Loctite UK 1366, Loctite UK U-09FL, Loctite UK U-05FL, Loctite UK 3364. Combination of these polyurethane polymer compositions are useful.

Non-limiting examples of useful silicone-modified polymers compositions for use as the debonding coating matrix include commercially available silicone-modified compositions such as those sold by the Henkel Corporation, such as Loctite MS 939, Loctite MS 930, Loctite MS 9399 and Loctite MS 647. Combination of these silicone-modified polymers compositions are useful.

The debonding coating includes the incorporation into the adhesive matrix about 1% to about 60%, or 10% to about 20%; or about 15% to about 30%; or about 30% to about 40%; or about 20% to about 50%; or about 25% to about 60% of heat expandable microparticles. The microparticles desirably are microspheres, which upon the application of a specific temperature, expand within the matrix, causing the cured matrix to debond from the surface of the substrate upon which it was cured.

The amount of heat expandable microparticles present in the matrix may be selected to tailor and control the debonding. For example, a higher amount of microparticles may be required for certain debonding matrices. For flexible coating matrix where expandable particle can readily expand upon heating, the amount of expandable particle needed will be low; on the other end, a hard and brittle coating may also need smaller amount of debondable particles as small amount of expansion is enough to cause crack and delamination from the surface. For tough coating matrix a higher amount of expandable particle is often needed, otherwise after heat expansion the coating may become a foamy but still strong coating. Also, the expansion temperature is also a determining factor in controlling the debonding. It is an aspect of the invention that the debonding coating composition be capable of remaining substantially intact during the curing of the bonding adhesive which is deposited thereon. This require the curing temperature of the bonding adhesive to be lower than the debonding temperature of the coating. Thus, the cured debonding coating composition will be substantially unaffected by the curing temperatures of the bonding adhesive and will also be compatible with the bonding adhesive and not interfere with the adhesive properties of the bonding adhesive.

One particularly useful heat-expandable microsphere is made from polyacrylonitrile shell and a hydrocarbon core, such as those sold under the trade names DUALITE® AND EXPANCEL®. The expandable microspheres may have any expanded size, including from about 5 microns to about 40 microns in diameter. In the presence of heat, the microspheres may increase from about 3 to about 80 times, desirably about 20 to about 80 times, and more desirably about 60 to about 80 times their diameter. The microspheres resemble tiny Ping-Pong balls with a diameter of about 5 to about 40, and consist of a polymer shell that encapsulates a blowing agent. When the microspheres are heated, the blowing agent will increase the pressure at the same time as the polymer shell will become soft and ductile and this causes the microspheres to expand. Once the microspheres are expanded, expanded volume is retained after cooling. Expanded microspheres have a particularly low density (1570 kg/m³). Microspheres also offer other useful features like thermal insulation, sound insulation, increased solar reflection and increased friction on surfaces. The thermal expansion makes it suitable to use as an expanding agent or foaming agent, and it offers a more controlled and uniform foam structure when compared to other foaming agents.

Microspheres may be made from a thermoplastic polymeric shell, which surrounds a core containing a volatile hydrocarbon within. When the microspheres are heated, the hydrocarbon vaporizes and the internal pressure is increased in the microsphere. At the same time, the polymeric shell becomes soft and ductile as it reaches its glass transition temperature (T_{g}). The microspheres start to expand when the internal pressure of the hydrocarbon gas exceeds the yield strength of the polymer and the decrease in density is substantial since the mass remains the same while the volume increases tremendously. The hydrocarbon works as a blowing agent, and the expansion is controlled by the type and amount of encapsulated blowing agent and the T_{g} of the polymer. The expansion continues as long as the internal pressure exceeds the yield strength of the polymer shell, or until the shell breaks, or becomes so thin that the hydrocarbon diffuses through the shell, causing the microspheres to decrease in volume.

The microspheres particularly useful in the present invention have a shell that is made of a copolymer of acrylonitrile (ACN), methacrylonitrile (MAN) and methyl acrylate (MA). ACN is the major component and is used because of its excellent barrier properties and chemical resistance, which is due to its semicrystalline structure and high cohesive strength. The barrier properties are very important for the expansion of the microspheres since they determine how much of the blowing agent that is lost through diffusion through the polymer shell which is detrimental for the expansion. MA may be added to lower the T_{g} and as a result making the shell more ductile. Another way to alter the properties of the polymer shell is to introduce a cross-linker, which decreases the mobility of the polymer chain and increases the T_{g}. The structure then becomes denser and this will increase the shell's chemical resistance. Cross-linking of the shell is known to have a large effect of the expansion properties, especially on Tₘₐₓ, the temperature when maximum expansion occurs. The expansion properties of the microspheres can be altered by using different hydrocarbons as blowing agents. The temperature at which the microspheres start to expand is related to the boiling point of the hydrocarbon; a lower boiling point will give a lower expansion temperature and vice versa.

The expandable microspheres have a particular temperature at which they begin to expand Tᵢ (initial expansion temperature) and a second temperature at which they have reached maximum expansion. Microsphere grades are typically sold with specific expansion temperature ranges (Texp), with initial (Tᵢ) and maximum expansion temperatures (Tmax). The initial expansion temperature (Tᵢ) is the typical temperature at which the microspheres start to expand, and the maximum expansion temperature (Tmax) is the temperature at which about 80% of the microspheres have expanded.

Polyacrylonitrile (PAN), also known as polyvinyl cyanide and Creslan 61, is a synthetic, semicrystalline organic polymer resin, with the linear formula (C₃H₃N)ₙ. Though it is thermoplastic, it does not melt under normal conditions. It degrades before melting. It melts above 300° C. if the heating rates are 50 degrees per minute or above. Almost all PAN resins are copolymers made from mixtures of monomers with acrylonitrile as the main monomer. It is a versatile polymer used to produce large variety of products including ultra filtration membranes, hollow fibers for reverse osmosis, fibers for textiles, oxidized PAN fibers. PAN is a component repeat unit in several important copolymers, such as styrene-acrylonitrile (SAN) and acrylonitrile butadiene styrene (ABS) plastic.

The debondable coating compositions of the present disclosure include the following characteristics:

| Parameter | Broad range | Narrower range |
|---|---|---|
| Service temperature | −90 C. to 170 C. | −50 C. to 150 C. |
| Debonding temperature | 70 C. to 250 C. | 110 C. to 200 C. |
| Thermal expandable | 1% to 60% | 5% to 40% |
| particle loading | | |

The debondable coating compositions of the present invention optionally may further include any plasticizers, tackifiers, humectants, fillers, pigments, dyes, stabilizers, rheology modifiers, polyvinyl alcohols, preservatives, e.g., antioxidant, biocide; and mixtures thereof. These components can be included in an amount of from about 0.05% to about 15% by weight of the debondable coating compositions.

Useful bonding adhesives may be selected from any adhesive composition which is capable of bonding to the debonding coating composition. Non-limiting examples of classes of bonding adhesives include acrylic-based adhesives, epoxy adhesives, polyurethane (PU) adhesives, silicone-modified adhesives, cyanoacrylate adhesives, hot-melt adhesives, copolymeric adhesives such as PU/acrylics, epoxy/acrylics, silicone/acrylics, and combinations of these adhesives. The limitation with respect to the selection of the bonding adhesive is that the bonding adhesive's curing temperature cannot be higher than the debondable coating's debondable temperature. When a higher curing temperature is required, then a higher temperature debondable coating should be used (e.g., coating with higher temperature expanding particles).

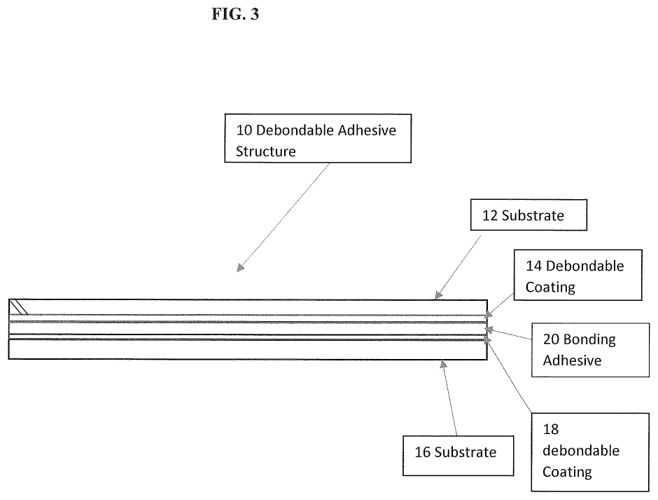

The debondable coating compositions may be used in adhesive bonding applications as show in FIG. 3. FIG. 3 shows debondable structure 10, having substrates 12 and 16 bonded together. The debondable coatings compositions, 14 and 18 respectively, have been applied as a pre-coating to opposing surfaces of the mating substrates as show at and cured, followed by application of the bonding adhesive 20, which is further cured to complete the bonding of the substrates together. The debonding coating composition may also be applied only to one of the mated substrates if desired. The debondable coatings 14 and 18, as described previously herein, may be selected from epoxies, silicones, polyurethanes and silicone modified polymers, as well as copolymers and combinations of these polymers. The debondable coating may be the same composition on each substrate surface, or the debondable coating compositions may be different on one surface than on the opposing surface, to allow for debonding at one substrate surface to be conducted under different conditions, i.e. different temperatures, from the opposing surface. Application of heat at temperatures of about 70° C. to about 250° will cause the expansion of the debonding adhesive, resulting in debonding from the substrates. As mentioned above, the debonding coating composition may be selected from epoxies, silicones, polyurethanes and silicone modified polymers, as well as copolymers and combinations of these polymers.

Also as described herein, the bonding adhesive 20 may be selected from any adhesive composition which is capable of bonding to the debonding coating and includes acrylic-based adhesives, epoxy adhesives, polyurethane (PU) adhesives, silicone-modified adhesives, cyanoacrylate adhesives, hot-melt adhesives, copolymeric adhesives such as PU/acrylics, epoxy/acrylics, silicone/acrylics, and combinations of these adhesives. The adhesive should not be an adhesive requiring a curing temperature above the debonding temperature of the debondable coating. Ideally the debonding coating strength at service temperature range should be higher than the bonding adhesive strength, so that the user will not encounter unexpected bond failure.

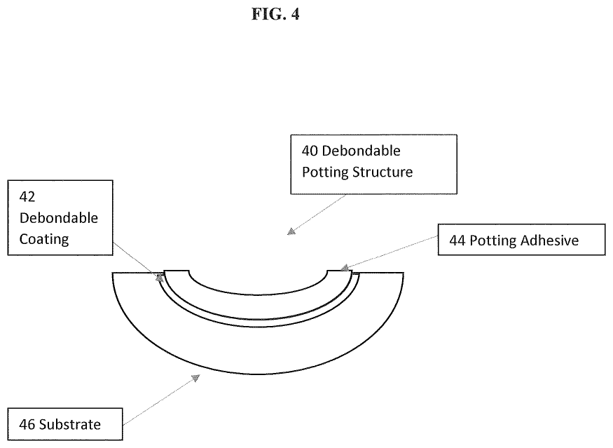

FIG. 4 shows a cross section of a debondable Potting Structure 40, having a debondable coating 42 on substrate 46 and potting adhesive 44 on the debondable coating 42. Any of the debonding coating compositions recited herein may be used, in combination with any of the bonding adhesives recited herein as the potting adhesive.

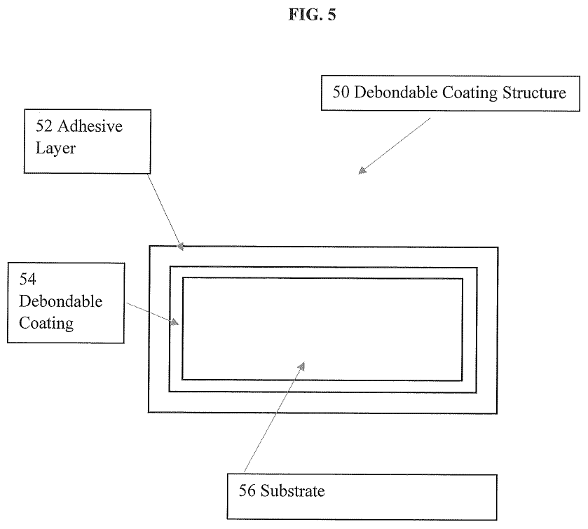

FIG. 5 shows a cross section of a debondable Coating Structure 50, having a debondable coating 54 on substrate 56 and bonding adhesive 52 over the debondable coating 54. The bonding adhesive 52 serves to provide overall protection to the substrate 56, such as an electronic component or other sensitive part requiring protection from the surrounding environment. Any of the debonding coating compositions recited herein may be used, in combination with any of the bonding adhesives recited herein as the bonding protective adhesive.

Debonding coating thicknesses may range from about 1 mil (0.00254 cm) to about 20 mils (0.0508 cm), or about 2 mils (0.00508 cm) to about 10 mils (0.0254 cm), or about 3 mils (0.00762 cm) to about 5 mils (0.0127 cm), depending on the substrate and chosen application.

### EXAMPLES

### Example 1

An inventive debonding coating composition was formulated by mixing 20% by weight of polymeric microspheres (Commercially available as Expancel® 031 DU 40) into a commercially available epoxy composition, Loctite E-120H, which is a fast setting industrial grade epoxy resin designed to cure at room temperature. This epoxy has particular use for bonding, potting or encapsulating a variety of substrates, including plastic, metal, glass, wood and ceramic substrates. The inventive debonding coating composition was applied to aluminum lapshears (1″×½″), with some lapshear pairs having the coating on both of the lapshears to be mated, and other lapshear pairs having the debonding coating on only one of the lapshears to be mated. The debonding coating compositions were allowed to cure at room temperature.

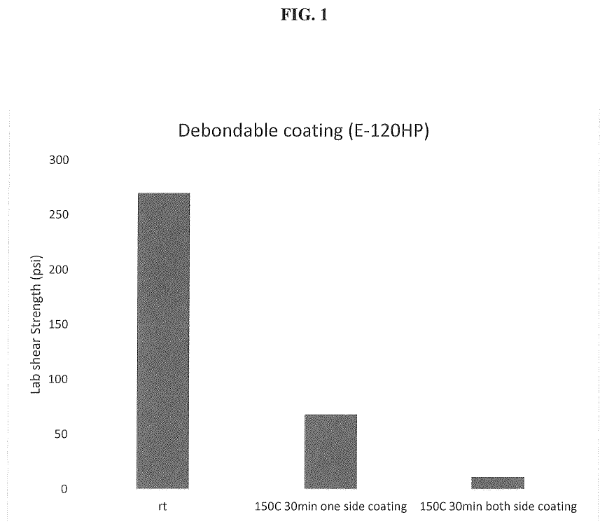

Subsequent to the curing of the debonding coating, a commercially available silicone adhesive composition (Loctite SI 5600), also referred to herein as the “bonding adhesive, was applied over the debonding coating and the lapshears were then mated and allowed to cure. Once the silicone adhesive was fully cured, some of the lapshears were pulled at room temperature, and others were pulled after heating under relatively mild temperatures (30 minutes at 150° C.) and the tensile strengths recorded in pounds per square inch (psi). FIG. 1 shows the initial room temperature (RT) strengths of the lapshears, as well as the debonding strengths after a short exposure time (30 minutes) at 150° C. (for both one sided and two sided debonding coatings). As shown in FIG. 1, the initial bond strength of 270 psi is within the range of what would be expected from the silicone adhesive under normal RT conditions, and thus the silicone bond strength was unaffected by the presence of the debonding coating. However, once the debonding coating was exposed to temperatures of 150° C. for 30 minutes, the lapshears having the deboning coating on only one surface showed a lapshear strength (68.2 psi) substantially lower (75% lower) than the original RT lapshear strength (270 psi), indicating that the debonding coating allowed the bonded parts to be separated using substantially less force (about 25% of the force) upon the application of a relatively mild heat treatment, without interfering with the original adhesive bond strength of the bonding adhesive (silicone). When both mating sides of the lapshears were coating with the debonding coating, the debonding strength (11.4 psi) was even further lowered (about 95% lower) from the actual RT strengths (270°). Additionally, after heating and testing of the lapshears, the debonding coating was easily cleaned from the surfaces, taking the silicone adhesive along with it. Thus, the lapshear tests demonstrated that the parts can not only be easily separated due to the debonding coating, but also the substrate was reclaimable (reusable) due to the ability to easily remove the debonding coating and the silicone adhesive from the surfaces without destroying the substrate surface.

### Example 2

An inventive debonding coating composition was formulated by mixing 20% by weight of polymeric microspheres (Commercially available as Expancel® 031 DU 40) into a commercially available epoxy composition, Loctite E-90-F, which is a fast setting industrial grade epoxy resin designed to cure at room temperature. The inventive debonding coating composition was applied to lapshears as a pre-coating prior to application of the bonding adhesive (silicone) and allowed to cure. Some of the lapshears received the debonding coating only on one of the mating lapshears, and other lapshears received the debonding coating on both of the mating surfaces of the lapshears.

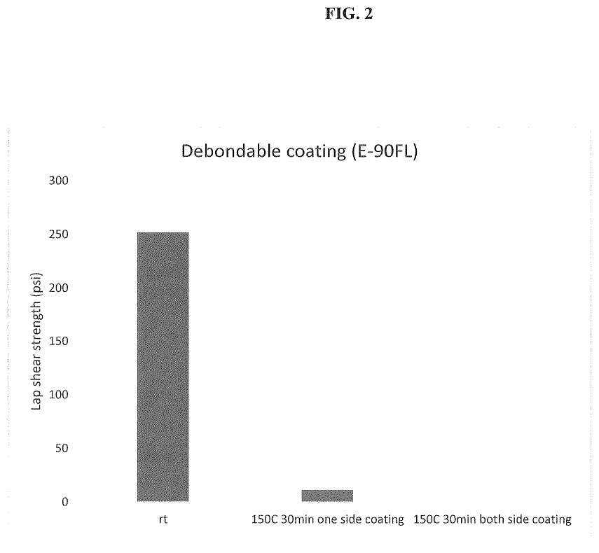

Subsequent to curing of the debonding coating, commercially available silicone adhesive composition (Loctite SI 5600) was applied over the debonding coating and allowed to cure. The lapshears were pulled both at room temperature, as well as at under relatively mild heating (30 minutes at 150° C.), and the strengths recorded in pounds per square inch (psi). FIG. 2 shows the initial room temperature (RT) strengths of the lapshears, as well as the debonding strengths after a short exposure time (30 minutes at 150° C.) for both one sided and two sided debonding coatings. As shown in FIG. 2, the initial strength of 252 psi is within the range of what would be expected from the silicone adhesive under normal RT conditions, and thus the silicone bond strength was unaffected by the presence of the debonding coating. However, once the debonding coating was exposed to temperatures of 150° C. for 30 minutes, the lapshears having the deboning coating on only one surface showed a lapshear strength of 11.6 psi, substantially lower (about 96% lower) than the original RT lapshear strength of 252 psi, indicating that the debonding coating allowed the bonded parts to be separated using substantially less force upon the application of a relatively mild heat treatment, without interfering with the original adhesive bond strength of the bonding adhesive (silicone). When both mating sides of the lapshears were coating with the debonding coating, the debonding strength too low to measure and the lapshears easily separated requiring little or no force. Additionally, after heating and testing of the lapshears, the debonding coating was easily cleaned from the surfaces, taking the silicone adhesive along with it. Thus, the lapshear tests demonstrated that the parts can not only be separated easily due to the debonding coating, but also rendered the substrate reclaimable (reusable) due to the ability to easily remove the debonding coating from the surfaces without destroying the substrate surface.

1. An adhesive debonding coating composition for thermally debonding a cured adhesive bond-line from a substrate, said debonding coating comprising:
a curable adhesive matrix capable of withstanding temperatures greater than about 250° C. when cured, said matrix including about 1% to about 60% by weight of heat expandable polymeric microparticles which expand when subjected to temperatures of about 70° C. to about 250° C.

2. The debonding coating composition of claim 1, wherein the curable adhesive matrix is selected from the group consisting of epoxies, silicones, polyurethanes, silicone-modified-polymers and copolymers and combinations thereof.

3. The debonding coating composition of claim 1, wherein the heat expandable polymeric microparticles are present in amounts of about 10% to about 30% of the curable adhesive matrix.

4. The debonding coating composition of claim 1, wherein the heat expandable polymeric microparticles have an average size of about 2 μm to about 50 μm as measured across the largest dimension.

5. The debonding coating composition of claim 1, wherein the microparticle initiation temperature of expansion is about 50° C. to about 180° C.

6. The debonding coating composition of claim 1, wherein microparticle are microspheres.

7. The debonding coating composition of claim 6, wherein microspheres comprise a polyacrylonitrile shell containing a heat expandable hydrocarbon.

8. The debonding coating composition of claim 7, wherein the heat expandable hydrocarbon is a liquid or a gas.

9. The debonding coating composition of claim 8, wherein the heat expandable hydrocarbon is a gas selected from butane, isobutene, pentane, isopentane and combinations thereof.

10. A method of forming debondable adhesion to a substrate comprising:
applying to a surface of said substrate a composition comprising:
a. a first debonding layer comprising an adhesive matrix and heat expandable microparticles, said microparticles capable of expanding at temperatures of about 70° C. to about 250° C., and said adhesive matrix capable of withstanding temperatures greater than said expansion temperatures;
b. a second layer comprising a curable bonding adhesive which is capable of withstanding temperatures greater than the expansion temperatures; and
curing said composition on said substrate,
wherein subsequent to said curing, the substrate can be separated from the adhesive layers by heating to said expansion temperature.

11. The method of claim 10, wherein the first debonding layer has stronger adhesive strength, as measured by lap shear tests, than the bonding layer.

12. The method of claim 10, wherein the first layer is at least partially cured prior to the deposition of the second layer.

13. The method of claim 10, wherein the adhesive debonding matrix is selected from the group consisting of epoxies, silicones, polyurethanes, silicone-modified-polymers and combinations and copolymers thereof.

14. The method of claim 10, wherein the debonding occurs in 30 minutes or less.

15. The method of claim 10, wherein the substrate is reclaimable after debonding.

16. A structure comprising at least one surface, said at least one surface comprising a cured debonding coating layer in direct contact with said surface and an additional adhesive bonding layer over said debonding coating,
wherein said debonding layer comprises an adhesive matrix capable of withstanding temperatures greater than about 250° C. and heat expandable microparticles, wherein upon heating the microparticles to a temperature of about 70° to about 250° C., the microparticles expand to cause debonding of the coating and bonding layers from the surface.

17. The adhesive structure of claim 16, wherein the structure is reclaimable (reusable).

18. A method of forming a debondable adhesion to a substrate comprising:
applying to a surface of said substrate a composition comprising:
a) a first debonding layer in direct contact with said surface, said debonding layer comprising an adhesive matrix selected from the group consisting of epoxies, silicones, polyurethanes, silicone-modified-polymers and copolymers and combinations thereof, and heat expandable microparticles capable of expanding at temperatures of about 70° C. to about 250° C.;
b) a second layer overlaying said debonding layer, said second layer comprising a curable bonding adhesive which has lower adhesive strength, as measured by lapshear tests, than the first debonding layer; and
allowing said composition to cure on said substrate, wherein subsequent to said curing, the substrate can be separated from the adhesive layers by heating to said expansion temperatures.

19. A heat-debondable adhesive joint comprising:
a first substrate surface and a second substrate surface, said first and second surfaces in mating arrangement to define a heat debondable adhesive bond-line therebetween;
a debonding coating composition on at least one of said mating surfaces, said coating composition comprising an epoxy adhesive matrix which includes from about 1% to about 60% by weight of heat expandable microspheres, said microspheres comprising an acrylonitrile shell and a hydrocarbon core; and
an adhesive bonding composition overlaying said debonding coating composition, said bonding composition comprising an adhesive which is compatible with said debonding composition and having a lower adhesive lap shear strength than said debonding composition,
wherein upon activation of a temperature from about 70° C. to about 250° C., the heat expandable microspheres cause debonding pf said substrates from each other.

20. The heat-debondable adhesive joint of claim 19, wherein adhesive bonding composition is capable of withstanding temperatures greater than the expansion temperatures.

21. The heat-debondable adhesive joint of claim 19, wherein the debonding coating composition has a greater adhesive strength as measured by lap shear tests than the adhesive strength of the adhesive bonding composition.
